(19) United States
(12) Patent Application Publication
(10) Pub. No.: US 2005/0229020 A1
(43) Pub. Date: Oct. 13, 2005

(54) Error handling in an embedded system

(75) Inventors: Brian G. Goodman, Tucson, AZ (US); Ronald F. Hill, Tucson, AZ (US); Frank D. Gallo, Tucson, AZ (US); Jonathan E. Bosley, Tucson, AZ (US)

Correspondence Address: SWANSON & BRATSCHUN, LLC - IBM, 1745 SHEA CENTER DRIVE, SUITE 330, HIGHLANDS RANCH, CO, 80129, US

(73) Assignee: International Business Machines (IBM) Corporation, Armonk, NY (US)

(21) Appl. No.: 10/818,907

(22) Filed: Apr. 6, 2004

(51) Int. Cl. G06F 11/00; G11B 5/596

(52) U.S. Cl. 714/2

(57) ABSTRACT

Disclosed are a system, a method, and a computer program product to provide improved error handling in an embedded system. When the embedded system encounters a fatal error, information pertaining to the error is saved and an indication that the error has occurred is also saved. The embedded system resets itself to allow normal operation to resume. Before or after the reset, the embedded system sets an indication of the prior error so that a human or a machine will be alerted to the fact that the embedded system had encountered the error. At some point in time, the error information may be retrieved, collected or sent for post error analysis. The error flag and/or error status is then cleared to remove the current error condition and/or allow a subsequent error to be managed.

### TECHNICAL FIELD

The present invention relates to embedded devices. More particularly, the invention concerns a method to provide improved error handling in an embedded system.

### BACKGROUND ART

Computer processor control in embedded devices allows a level of flexibility to the embedded system which can reduce costs while improving product quality. Examples of embedded systems which provide a unique function or service and which contain at least one microprocessor may comprise modems, answering machines, automobile controls, data storage disk drives, data storage tape drives, digital cameras, medical drug infusion systems, storage automation products, etc. Sometimes a product comprising an embedded system will encounter an error that prevents the device from further operation. An example may comprise a processor exception, such as the attempted execution of an illegal instruction or an off boundary memory access error. In many cases, displaying an error is all the embedded system can do. This is because the error may be severe enough that a proper error recovery procedure cannot be determined by the embedded system. For example, if the execution of an illegal instruction is attempted then it may be an indication that program memory is corrupted. An attempt to continue product operation when memory is corrupted could lead to unpredictable operation of the embedded system and the error could become more serious than it already is, by causing customer data corruption, loss of life, etc., depending on the intended function of the embedded system. One possible course of action for handling such an error would be a reset of the embedded system. The problem with this approach is that problem determination can be difficult or impossible once the device has been reset. This is because a reset may cause error information to be lost or it may cause a secondary error that disrupts overall system operation. An example may comprise an automated data storage library where a processor exception results in a reset error recovery but the reset causes a host application error. When a repair technician is called out to analyze the failure, any original error information may be lost by the reset and the only remaining information may relate to the error caused by the reset. The original error information could be stored in nonvolatile memory but other subsequent errors could cause the original error to be overwritten. In addition, the embedded system may not contain nonvolatile memory that can be written in a random access manner. As customer expectations move toward a concept of continuous availability, such as the well known “24×7×365” availability, it is increasingly important that errors do not disrupt customer operations and that problem determination can be handled quickly to avoid any future outages.

Therefore, there is a need to provide improved error recovery and problem determination in an embedded system.

### SUMMARY OF THE INVENTION

The method of the invention begins when an embedded system encounters a fatal error. Information pertaining to the error is saved so that it will be available after a subsequent reset. An error flag is optionally set or saved as an indication that the error has occurred. This allows the embedded system to know, after a reset, that the error had occurred before the reset. The embedded system then resets itself to correct the fatal error and proceed with normal operation. During or after the reset, the embedded system sets optional error status as an indication of the prior error so that a human or a machine will be alerted to the fact that the embedded system had encountered the error. This may lead to the eventual collection of some or all of the error information. At some point in time, the error information may be retrieved, collected or sent. Use of the error information facilitates problem determination because the reset that allows normal operation to resume could eventually cause a secondary error. The sooner the original error condition is fixed, the less likely that a product will experience a secondary error as the result of the reset. The error flag and/or error status is optionally cleared as a result of retrieving, collecting or sending the error information. This may be desired to prevent the error from persisting after the error information has been obtained. This may also be desired to indicate that a subsequent error may overwrite the information pertaining to the original error.

### BRIEF DESCRIPTION OF THE DRAWINGS

FIG. 1 is a block diagrammatic representation of an embedded system.

FIG. 2 illustrates an example of an embedded system which comprises an automated data storage library with a left hand service bay, multiple storage frames and a right hand service bay.

FIG. 3 illustrates the minimum configuration of the automated data storage library of FIG. 2.

FIG. 4 illustrates an embodiment of an automated data storage library which employs a distributed system of embedded modules with a plurality of processor nodes.

FIG. 5 illustrates another example of an embedded system which comprises a front and rear view of a data storage drive mounted in a hot-swap drive canister.

FIG. 6 is a flow chart which illustrates the method of the first embodiment of this invention.

FIG. 7 is a flow chart which illustrates the method of the second embodiment of this invention.

FIG. 8 is a flow chart which illustrates the method of the third embodiment of this invention.

### DETAILED DESCRIPTION OF THE PREFERRED EMBODIMENT

This invention is described in preferred embodiments in the following description. The preferred embodiments are described with reference to the Figures. While this invention is described in conjunction with the preferred embodiments, it will be appreciated by those skilled in the art that it is intended to cover alternatives, modifications, and equivalents as may be included within the spirit and scope of the invention as defined by the appended claims.

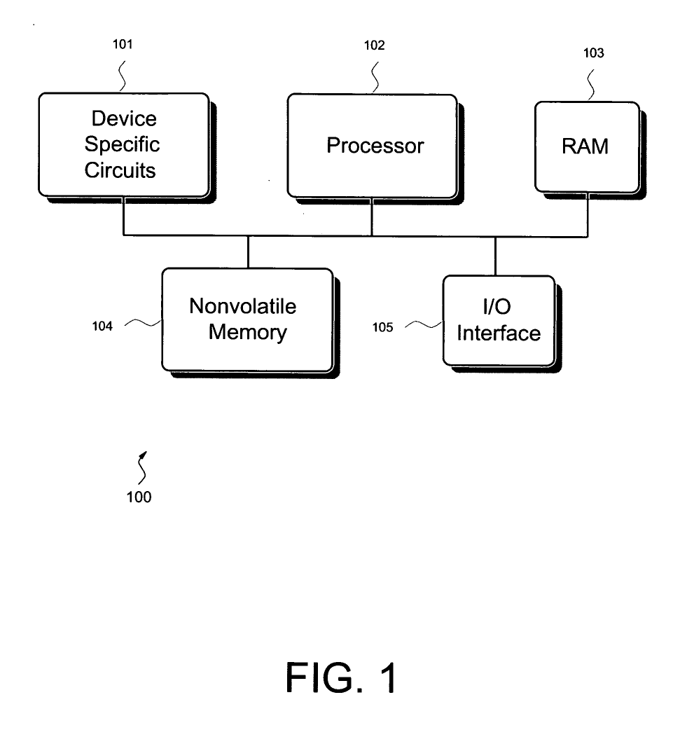

A data storage drive typically comprises one or more embedded controllers to direct the operation of the data storage drive. Storage subsystems typically comprise similar controllers. The controller may take many different forms and may comprise a single embedded system, a distributed control system, etc. FIG. 1 shows a typical embedded controller 100 with a processor 102, RAM (Random Access Memory) 103, nonvolatile memory 104, device specific circuits 101, and I/O interface 105. Alternatively, the RAM 103 and/or nonvolatile memory 104 may be contained in the processor 102 as could the device specific circuits 101 and I/O interface 105. The processor 102 may comprise an off the shelf microprocessor, custom processor, FPGA (Field Programmable Gate Array), ASIC (Application Specific Integrated Circuit), discrete logic, etc. The RAM (Random Access Memory) 103 is typically used to hold variable data, stack data, executable instructions, etc. The nonvolatile memory 104 may comprise any type of nonvolatile memory such as ROM (Read Only Memory), EEPROM (Electrically Erasable Programmable Read Only Memory), PROM (Programmable Read Only Memory), flash PROM, MRAM (Magnetoresistive Random Access Memory), battery backup RAM, hard disk drive, etc. The nonvolatile memory 104 is typically used to hold the executable firmware and any nonvolatile data. The I/O interface 105 is a communication interface that allows the processor 102 to communicate with devices external to the controller. Examples may comprise, but are not limited to, serial interfaces such as RS-232 (Recommended Standard) or USB (Universal Serial Bus), SCSI (Small Computer Systems Interface), Fibre Channel, Ethernet, etc. The device specific circuits 101 provide additional hardware to enable the controller 100 to perform unique functions such as, but not limited to, motor control of a cartridge gripper, etc. The device specific circuits 101 may comprise electronics that provide, by way of example but not limitation, Pulse Width Modulation (PWM) control, Analog to Digital Conversion (ADC), Digital to Analog Conversion (DAC), etc. In addition, all or part of the device specific circuits 101 may reside outside the controller 100.

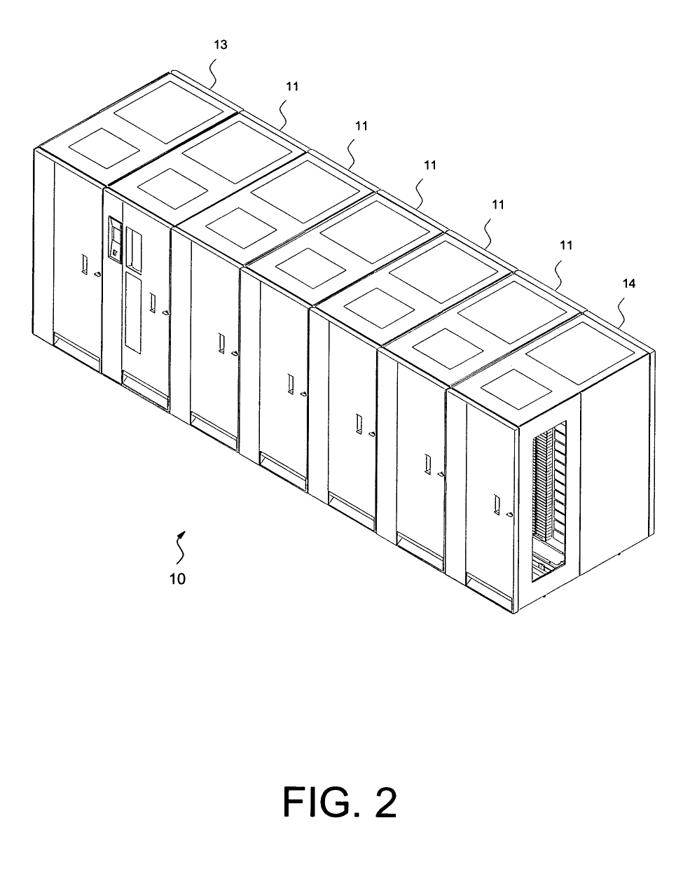

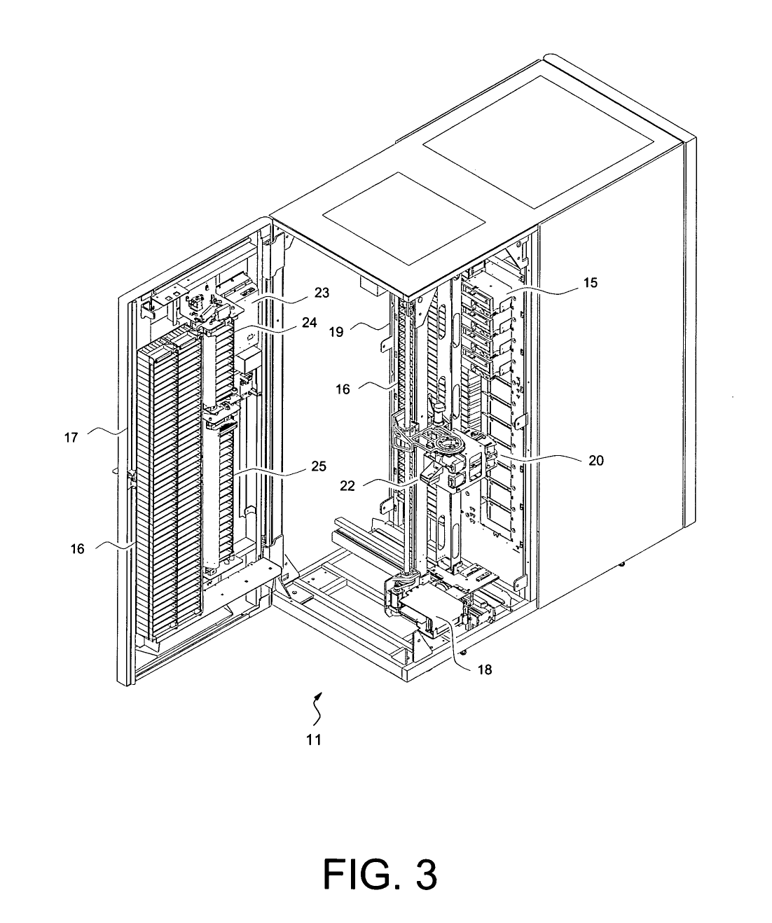

FIG. 2 illustrates an automated data storage library 10 with left hand service bay 13, one or more storage frames 11, and right hand service bay 14. As will be discussed, a frame may comprise an expansion component of the library. Frames may be added or removed to expand or reduce the size and/or functionality of the library. Frames may include additional storage shelves, drives, import/export stations, accessors, operator panels, etc. FIG. 3 shows an example of a storage frame 11, which is contemplated to be the minimum configuration of the library 10. In this minimum configuration, there is a single accessor and no service bay. The library is arranged for accessing data storage media in response to commands from at least one external host system (not shown), and comprises a plurality of storage shelves 16, on a front wall 17 and a rear wall 19, for storing data storage cartridges that contain data storage media; at least one data storage drive 15 for reading and/or writing data with respect to the data storage media; and a first accessor 18 for transporting the data storage media between the plurality of storage shelves 16 and the data storage drive(s) 15. The data storage drives 15 may comprise optical disk drives or magnetic tape drives, or other types of data storage drives as are used to read and/or write data with respect to the data storage media. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage media to be inserted into the library and/or removed from the library without disrupting library operation. The library 10 may comprise one or more storage frames 11, each having storage shelves 16 accessible by first accessor 18. As described above, the storage frames 11, may be configured with different components depending upon the intended function. One configuration of storage frame 11 may comprise storage shelves 16, data storage drive(s) 15, and other optional components to store and retrieve data from the data storage cartridges. The first accessor 18 comprises a gripper assembly 20 for gripping one or more data storage media and may include a bar code scanner 22 or other reading system, such as a cartridge memory reader, smart card reader, RFID reader or similar system, mounted on the gripper 20, to “read” identifying information about the data storage media.

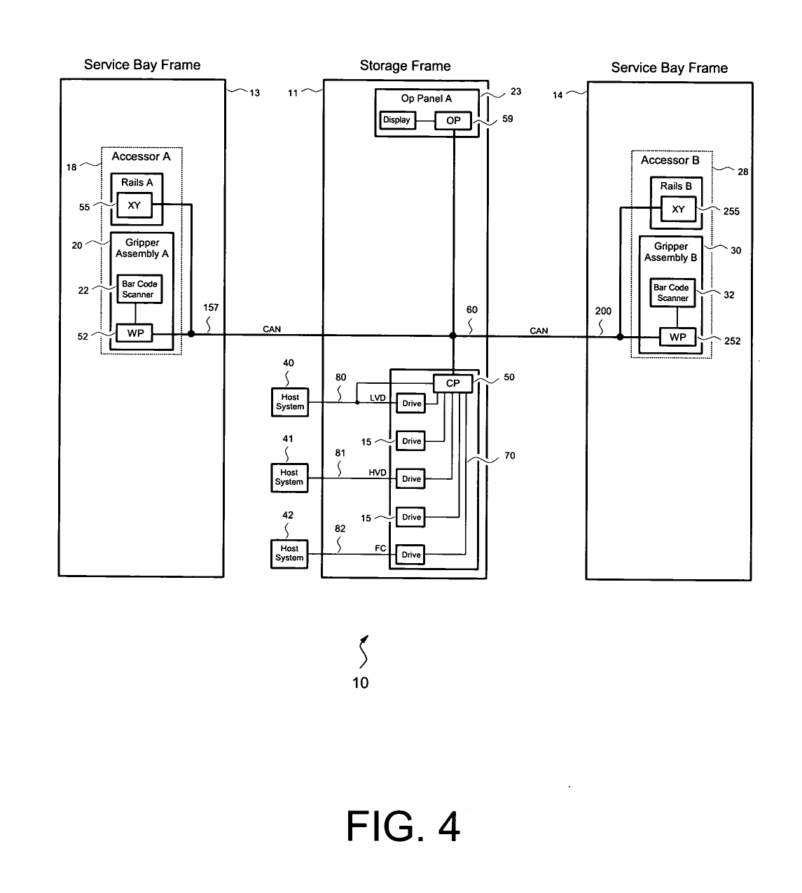

FIG. 4 illustrates an embodiment of an automated data storage library 10 of FIGS. 2 and 3, which employs a distributed system of modules with a plurality of processor nodes. An example of an automated data storage library which may implement the present invention is the IBM 3584 UltraScalable Tape Library. The library of FIG. 4 comprises one or more storage frames 11, a left hand service bay 13 and a right hand service bay 14. For a fuller understanding of a distributed control system incorporated in an automated data storage library, refer to U.S. Pat. No. 6,356,803, which is entitled “Automated Data Storage Library Distributed Control System,” which is incorporated herein for reference. While the automated data storage library 10 has been described as employing a distributed control system, the present invention may be implemented in automated data storage libraries regardless of control configuration, such as, but not limited to, an automated data storage library having one or more library controllers that are not distributed, as that term is defined in U.S. Pat. No. 6,356,803.

The left hand service bay 13 is shown with a first accessor 18. As discussed above, the first accessor 18 comprises a gripper assembly 20 and may include a reading system 22 to “read” identifying information about the data storage media. The right hand service bay 14 is shown with a second accessor 28. The second accessor 28 comprises a gripper assembly 30 and may include a reading system 32 to “read” identifying information about the data storage media. In the event of a failure or other unavailability of the first accessor 18, or its gripper 20, etc., the second accessor 28 may perform some or all of the functions of the first accessor 18. The two accessors 18, 28 may share one or more mechanical paths or they may comprise completely independent mechanical paths. In one example, the accessors 18, 28 may have a common horizontal rail with independent vertical rails. The first accessor 18 and the second accessor 28 are described as first and second for descriptive purposes only and this description is not meant to limit either accessor to an association with either the left hand service bay 13, or the right hand service bay 14.

In the exemplary library, first accessor 18 and second accessor 28 move their grippers in at least two directions, called the horizontal “X” direction and vertical “Y” direction, to retrieve and grip, or to deliver and release the data storage media at the storage shelves 16 and to load and unload the data storage media at the data storage drives 15. The commands are typically logical commands identifying the media and/or logical locations for accessing the media. The terms “commands” and “work requests” are used interchangeably herein to refer to such communications from the host system 40, 41 or 42 to the library 10 as are intended to result in accessing particular data storage media within the library 10.

The exemplary library 10 receives commands from one or more host systems 40, 41 or 42. The host systems, such as host servers, communicate with the library directly, e.g., on path 80, through one or more control ports (not shown), or through one or more data storage drives 15 on paths 81, 82, providing commands to access particular data storage media and move the media, for example, between the storage shelves 16 and the data storage drives 15. The commands are typically logical commands identifying the media and/or logical locations for accessing the media.

The exemplary library is controlled by a distributed control system receiving the logical commands from hosts, determining the required actions, and converting the actions to physical movements of first accessor 18 and/or second accessor 28.

In the exemplary library, the distributed control system comprises a plurality of processor nodes, each having one or more processors. In one example of a distributed control system, a communication processor node 50 may be located in a storage frame 11. The communication processor node provides a communication link for receiving the host commands, either directly or through the drives 15, via at least one external interface, e.g., coupled to line 80.

The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18, and that is coupled to the communication processor node 50 via a network 60, 157. Each work processor node may respond to received commands that are broadcast to the work processor nodes from any communication processor node, and the work processor nodes may also direct the operation of the accessors, providing move commands. An XY processor node 55 may be provided and may be located at an XY system of first accessor 18. The XY processor node 55 is coupled to the network 60, 157 and is responsive to the move commands, operating the XY system to position the gripper 20.

Also, an operator panel processor node 59 may be provided at the optional operator panel 23 for providing an interface for communicating between the operator panel and the communication processor node 50, the work processor nodes 52, 252 and the XY processor nodes 55, 255.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as one or more point to point connections, Ethernet, or a wireless network system, such as RF or infrared, may be employed in the library as is known to those of skill in the art. In addition, multiple independent networks may be used to couple the various processor nodes.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the hosts and with the data storage drives. In the example of FIG. 4, host connections 80 and 81 are SCSI busses. Bus 82 comprises an example of a Fibre Channel bus which is a high speed serial data interface, allowing transmission over greater distances than the SCSI bus systems.

The data storage drives 15 may be in close proximity to the communication processor node 50, and may employ a short distance communication scheme, such as SCSI, or a serial connection, such as RS422. The data storage drives 15 are thus individually coupled to the communication processor node 50 by means of lines 70. Alternatively, the data storage drives 15 may be coupled to the communication processor node 50 through one or more networks, such as a common bus network.

Additional storage frames 11 may be provided and each is coupled to the adjacent storage frame. Any of the storage frames 11 may comprise communication processor nodes 50, storage shelves 16, data storage drives 15, and networks 60.

Further, the automated data storage library 10 may additionally comprise a second accessor 28, for example, shown in a right hand service bay 14 of FIG. 4. The second accessor 28 may comprise a gripper 30 for accessing the data storage media, and an XY system 255 for moving the second accessor 28. The second accessor 28 may run on the same horizontal mechanical path as first accessor 18, or on an adjacent path. The exemplary control system additionally comprises an extension network 200 forming a network coupled to network 60 of the storage frame(s) 11 and to the network 157 of left hand service bay 13.

In FIG. 4 and the accompanying description, the first and second accessors are associated with the left hand service bay 13 and the right hand service bay 14. This is for illustrative purposes and there may not be an actual association. In addition, network 157 may not be associated with the left hand service bay 13 and network 200 may not be associated with the right hand service bay 14. Further, networks 60, 157 and 200 may comprise a single network or may comprise multiple networks. Depending on the design of the library, it may not be necessary to have a left hand service bay 13 and/or a right hand service bay 14. A feature often referred to as “Call-Home” is used to expedite service and repair of an automated data storage library. Call-home is a feature used by the library to call a service or repair center when it detects an operational error. Another feature, called “Heartbeat Call-Home” involves a periodic call to a service or repair center as a watchdog function. If the automated data storage library doesn't call home at some periodic interval then it may be an indication that there is a problem with the automated data storage library. The interface between a product that provides the call-home capability and a service or repair facility may comprise telephone lines, the internet, an intranet, a wireless link such as RF or infrared, dedicated communication lines such as Fibre Channel or ISDN, or any other means of interfacing two remote devices as is known to those of skill in the art. In addition, the automated data storage library may comprise communication to another product that actually provides the interface to the service or repair facility. For example, the library may comprise an Ethernet connection to a server and the server may have a connection to a call-home facility.

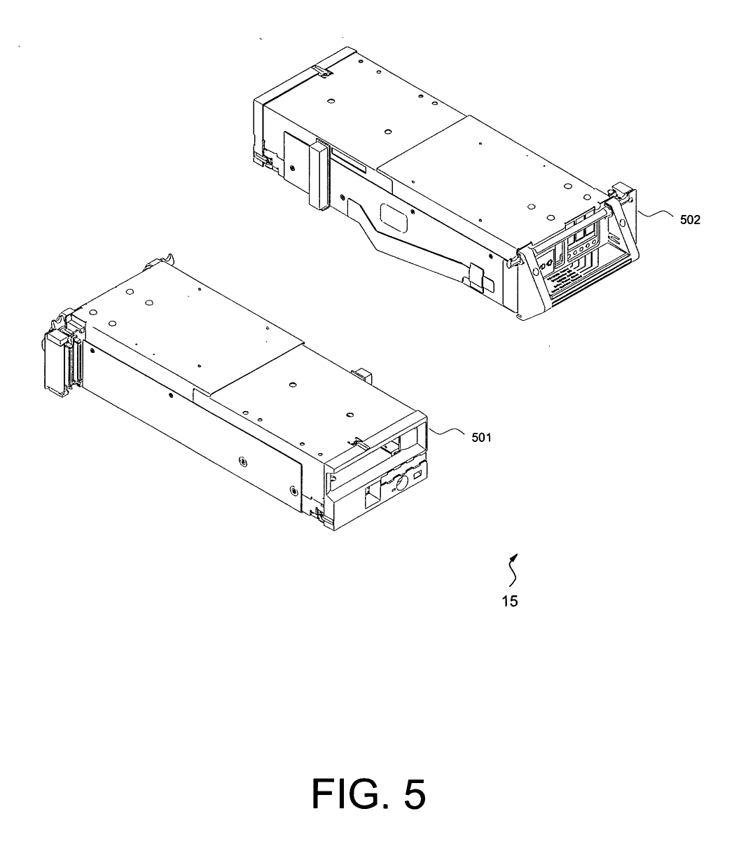

FIG. 5 shows a view of the front 501 and rear 502 of drive 15. In this example, drive 15 is a removable media LTO (Linear Tape Open) tape drive mounted in a hot swap canister. The data storage drive of this invention may comprise any removable media drive such as magnetic or optical tape drives, magnetic or optical disk drives, electronic media drives, or any other removable media drive as is known in the art. In addition, the data storage drive of this invention may comprise any fixed media drive such as hard disk drives or any other fixed media drive as is known in the art.

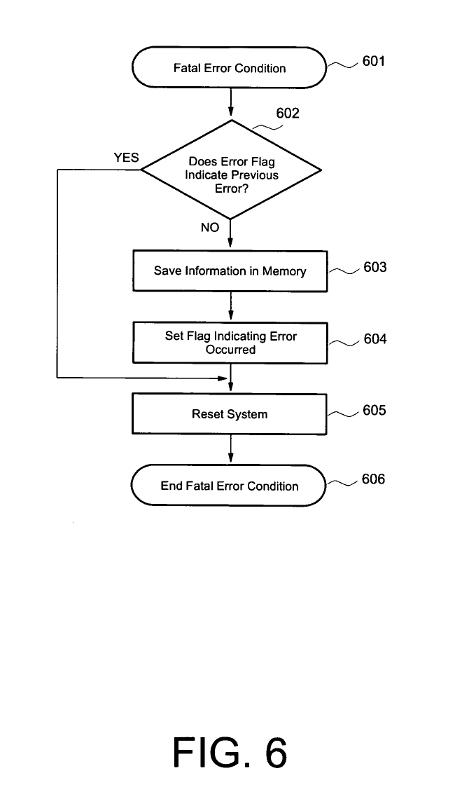

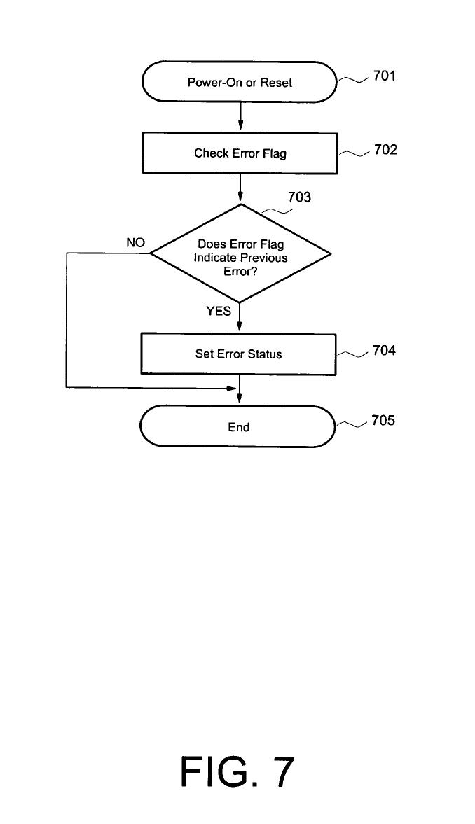

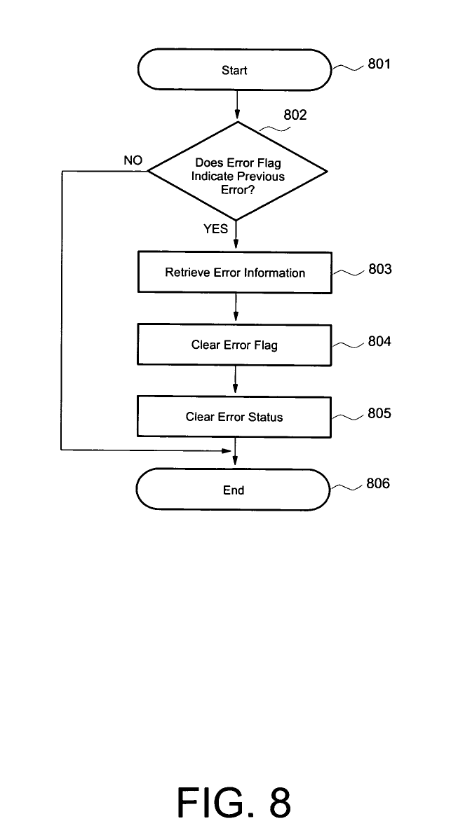

The method of the invention is illustrated by the flowcharts of FIGS. 6, 7, 8 and the accompanying description. The flowchart of FIG. 6 illustrates the steps of the method when a fatal error is encountered in an embedded system. FIG. 7 illustrates the steps of the method after the embedded system completes a reset and FIG. 8 illustrates the steps of the method when error information is retrieved, obtained or sent from the embedded system.

The method of the first embodiment is illustrated in the flowchart of FIG. 6. A fatal error is encountered at step 601. The fatal error may comprise any error that requires a reset to continue normal operation of the embedded system. Examples may include, but are not limited to, a processor exception, memory corruption, etc. A memory corruption may comprise memory that contains incorrect, unexpected or random data. A memory corruption may be caused by a code bug, alpha particles, electrical noise, electromagnetic radiation, component failures, etc. A processor exception may comprise an attempt to execute an illegal or unknown instruction, an attempt to access memory off an even address boundary, etc. The processor exception may be caused by a memory corruption, code bug, alpha particles, electrical noise, electromagnetic radiation, component failures, etc. The fatal error may be detected by the embedded system in a number of different ways. For example, the error may be detected by taking a hardware or software interrupt, reading the contents of registers or memory, from a watchdog timer, checksum or CRC (Cyclic Redundancy Check) results, hardware or software diagnostics, etc. Referring back to FIG. 6, an optional check is made to see if an error flag has been set to indicate that a previous error has occurred. This step performs a check of the error flag that is set in step 604. The error flag may be used, by the embedded system, to preserve information about an original error. For example, there may only be resources to save information about a limited number of fatal errors. Once these resources have been used, it may be desired to prevent any other information about subsequent fatal errors from being saved until the resources have been released. The error flag may be used to indicate that the resources have been consumed and subsequently released. The resources may be released after the error information has been retrieved, collected or sent, as will be discussed. In addition, the error flag may be inferred rather than actually comprising unique or dedicated information. For example, the presence of information from step 603 may imply that a previous error has occurred. In this case, the clearing or initialization of the memory used in step 603 would comprise a clearing of the error flag while saving information about the error in step 603 would comprise a setting of the error flag. Herein, the error flag may comprise unique or dedicated information or it may comprise inferred information. If the error flag is set as indicated in step 602, then control moves to step 605 where the embedded system is reset in an attempt to resume normal operation. This is because an error recovery may be desired even if the error flag indicates that there are no more resources available to store information about the error. If on the other hand, the error flag is not set as indicated in step 602, control moves to step 603 where information about the fatal error is saved. This information may comprise the type of error that occurred, the address where the error occurred, the value of memory or registers at the time of the error, a log of other activities that were taking place prior to the error such as, but without limitation, trace logs, error logs, command logs, etc. The information may be saved in volatile memory such as registers, flip-flops, latches, RAM (Random Access Memory), etc. Alternatively, the information may be saved in nonvolatile memory such as a hard disk drive, EEPROM (Electrically Erasable Programmable Read Only Memory), flash PROM (Programmable Read Only Memory), MRAM (Magnetoresistive Random Access Memory), battery backup RAM, etc. The decision to store the information in volatile or nonvolatile memory may be based on whether or not the volatile memory will be preserved through the subsequent reset. At step 604, an optional flag or signature is set in memory to indicate that the error has occurred and/or that information has been saved. The memory may comprise any volatile or nonvolatile memory as described above. The flag may comprise any detectable indication such as the setting or clearing of a particular bit (binary digit), a particular memory pattern or value, etc. The error flag may comprise multiple independent indications such as, but not limited to, an indication that a fatal error has occurred, an indication that a fatal error has not occurred, an indication that there are no more resources available for storing information about the fatal error, an indication that there are resources available for storing information about the fatal error, etc. As discussed above, the error flag may be inferred. In this case, step 604 may be eliminated. The embedded system causes or initiates reset at step 605. The reset is an attempt to correct the fatal error. The reset may comprise a power cycle of the processor or embedded system, a watchdog reset, a hardware reset, a software reset, a software branch, jump or call, etc. The process ends at step 606.

Steps of the flowchart may be changed, added or removed without deviating from the spirit and scope of the invention. For example, when present, the order of steps 603 and 604 may be reversed. In another example, step 602 may be removed. This is because it may be desired to save information about each occurrence of error, regardless if the prior error has been cleared, as will be discussed. Alternatively, step 602 and/or other parts of the flow chart may be modified to manage multiple copies of error information from step 603. In this case, there may be error information for each fatal error encountered. In a preferred embodiment, the embedded system comprises a distributed system of processor nodes. One or more nodes of the distributed system, such as communication processor node 50 of FIG. 4, may encounter a fatal error and execute the method of this invention. This may cause little or no disruption to the embedded system because the rest of the distributed control system may continue to operate in spite of the reset of one processor node.

The method of the second embodiment is illustrated in the flowchart of FIG. 7. The embedded system powers up or resets at step 701. This may comprise the reset of step 605 (FIG. 6) as discussed above. At step 702 the error flag of step 604 (FIG. 6) is checked. If the error flag does not indicate a previous error as indicated in step 703, then control moves to step 705 where the method of this embodiment ends. If on the other hand, the error flag indicates a previous error as indicated in step 703, then control moves to step 704 where an error status indicator is set. Setting an error status indicator may comprise the display of error information at an operator panel, user interface, or some other human readable display. For example, but without limitation, an error code indicating that the fatal error had occurred may be displayed at an operator panel. Alternatively or additionally, setting an error status indicator may comprise the reporting of error information to another processor node, embedded system or computer system through an interface such as a serial interface, wireless interface, or any interface known to those of skill in the art. For example, but without limitation, the error information from step 603 (FIG. 6) may be sent to a service or repair facility as part of a call-home operation. Still further, setting an error status indicator may comprise recording of error information in a log, such as an error log or trace log. For example, but without limitation, the embedded system may comprise an error log. Setting an error status indicator may comprise a new entry in the error log indicating that the fatal error had occurred. The error flag from step 604 (FIG. 6) may be optionally cleared in step 704. For example, it may be desired to only set the error status indicator once and not after each potential power cycle or reset of the embedded system. Alternatively, the error flag may be cleared after a period of time has elapsed or after some event or activity associated with the embedded system. The reset error handling ends at step 705.

Steps of the flowchart may be changed, added or removed without deviating from the spirit and scope of the invention. For example, it may be possible for the embedded system to set the error status indicator of step 704 prior to performing the reset of step 605 (FIG. 6). As another example, the steps of FIG. 7 may not be required to implement the invention because it may be desired to not record or report any information apart from the information that is saved at step 603 (FIG. 6).

The method of the third embodiment is illustrated in the flowchart of FIG. 8. The process begins at step 801. At step 802 a check is performed to see if the error flag of step 604 (FIG. 6) indicates that an error has occurred. If an error has not occurred as indicated in step 802, control moves to step 806 where the process ends. This is because there may not be any need to obtain error information if an error has not occurred. Alternatively, this step may be removed because there may not be an error flag, as discussed above. In addition, this step may be removed if it is desired to allow the error information to be obtained more than once after an error has occurred. Referring back to FIG. 8, if on the other hand, a previous error has occurred as indicated in step 802, then control moves to step 803 where error information from step 603 (FIG. 6) is retrieved, collected or sent. For example, an operator may use a diagnostic interface of the embedded system to retrieve the error information. Alternatively, the error information may be requested by, or sent to another processor or computer. In any case, the error information may be obtained through a serial interface, SCSI (Small Computer Systems Interface), Fibre Channel, USB (Universal Serial Bus), wireless interface, or any other interface known to those of skill in the art. Alternatively, the error information may be obtained through a human or machine readable display. In one embodiment, the error information is sent as part of a call-home operation. The error flag of step 604 (FIG. 6) is cleared in step 804. This may be desired to prevent the setting of the error status indicator (step 704 of FIG. 7) at the next reset or power cycle of the embedded system. Alternatively, or additionally, clearing the error flag at step 804 may allow another error to be logged. For example, it may be desired to prevent the error information from being overwritten by subsequent errors until the information has been retrieved. This may be desired to make problem determination easier as the first in a series of errors may more accurately point to the source of the problem. The error status indicator from optional step 704 (FIG. 7) is then cleared at step 805. This may comprise writing a value or a pattern to memory or registers, erasing the contents of memory or registers, or any action that indicates that the error status is no longer valid or present. The information collection process ends at step 806.

Steps of the flowchart may be changed, added or removed without deviating from the spirit and scope of the invention. For example, the order of steps 803 and 804 may be reversed. In addition, step 805 is an optional step and may be removed. For example, if the flowchart of FIG. 7 is removed then there is no need for step 805.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims.

1. A method for recovering from a fatal error in an embedded processor system, comprising:
detecting a fatal error;
storing information about the fatal error;
commencing a reset of the embedded processor system;
determining whether an error occurred prior to the commencement of the reset; and
if an error occurred, setting an error status indicator.

2. The method of claim 1, further comprising:
following the detection of a fatal error, determining if an error flag indicates a previous occurrence of an error;
if the error flag indicates the previous occurrence of an error, bypassing the step of storing information about the fatal error and commencing the reset of the embedded processor system; and
if the error flag does not indicate the previous occurrence of an error, setting the error flag to indicate the occurrence of the fatal error.

3. The method of claim 2, wherein the determining whether an error occurred prior to the commencement of the reset comprises determining the status of the error flag.

4. The method of claim 1, further comprising:
if an error occurred, retrieving stored error information; and
clearing the error status indicator.

5. The method of claim 4, further comprising:
following the detection of a fatal error, determining if an error flag indicates a previous occurrence of an error;
if the error flag indicates the previous occurrence of an error, bypassing the step of storing information about the fatal error and commencing the reset of the embedded processor system;
if the error flag does not indicate the previous occurrence of an error, setting the error flag to indicate the occurrence of the fatal error; and
following the retrieval of the stored error information, clearing the error flag.

6. The method of claim 4, wherein retrieving the error information comprises retrieving the error information on a human-readable display.

7. The method of claim 4, wherein retrieving the error information comprises providing the error information to a computer.

8. The method of claim 4, wherein retrieving the error information comprises providing the error information as part of a call-home operation.

9. The method of claim 1, wherein storing information about the fatal error comprises storing at least one of the type of: the type of error, the address at which the error occurred, the value of memory at the time of the error, the value of registers at the time of the error, and a log of other activities being performed prior to the error.

10. The method of claim 1, wherein storing information about the fatal error comprises storing information in a volatile memory.

11. The method of claim 1, wherein storing information about the fatal error comprises storing information in a non-volatile memory.

12. The method of claim 1, wherein setting the error status indicator comprises providing the status indicator on a human-readable display.

13. The method of claim 1, wherein setting the error status indicator comprises providing the status indicator to a computer system.

14. The method of claim 1, wherein setting the error status indicator comprises recording the error status indicator in a log.

15. The method of claim 1, wherein:
the embedded processor system comprises a distributed system having a plurality of nodes;
detecting a fatal error comprises detecting a fatal error in a first node; and
commencing a reset comprises commencing a reset of the first node.

16. An error recovery system for an embedded processor system, comprising:
means for detecting a fatal error;
means for storing information about the fatal error in a memory;
means for commencing a reset of the embedded processor system;
means for determining whether an error occurred prior to the commencement of the reset; and
an error status indicator for indicating if an error occurred.

17. The error recovery system of claim 16, further comprising:
an error flag for indicating an existence of a previous occurrence of an error following the detection of a fatal error;
means for bypassing the step of storing information about the fatal error and commencing the reset of the embedded processor system if the error flag indicates the previous occurrence of an error; and
means for setting the error flag to indicate the occurrence of the fatal error if the error flag does not indicate the previous occurrence of an error.

18. The error recovery system of claim 16, further comprising:
means for retrieving stored error information if an error occurred; and
means for clearing the error status indicator.

19. The error recovery system of claim 18, further comprising:
following the detection of a fatal error, means for determining if an error flag indicates a previous occurrence of an error;
means for bypassing the step of storing information about the fatal error and commencing the reset of the embedded processor system if the error flag indicates the previous occurrence of an error;
means for setting the error flag to indicate the occurrence of the fatal error if the error flag does not indicate the previous occurrence of an error; and
means for clearing the error flag following the retrieval of the stored error information.

20. The error recovery system of claim 16, wherein the memory comprises volatile memory.

21. The error recovery system of claim 16, wherein the memory comprises non-volatile memory.

22. The error recovery system of claim 16, wherein the error status indicator comprises a human readable display.

23. The error recovery system of claim 16, wherein the error status indicator comprises a computer readable signal.

24. The error recovery system of claim 16, wherein the error status indicator comprises an entry in a log.

25. The error recovery system of claim 16, wherein:
the embedded processor system comprises a distributed system having a plurality of nodes;
the means for detecting a fatal error comprises means for detecting a fatal error in a first node; and
the means for commencing a reset comprises means for commencing a reset of the first node.

26. An automated storage library, comprising:
a plurality of storage shelves for holding data storage cartridges;
at least one data storage drive for receiving a data storage cartridge and writing/reading data to/from media within the cartridge;
an accessor for transporting data storage cartridges between storage shelves and the at least one data storage drive;
a memory;
an error status indicator; and
an embedded processor programmed to execute instructions for:
detecting a fatal error in the automated storage library;
storing information about the fatal error in the memory;
commencing a reset of the embedded processor;
determining whether an error occurred prior to the commencement of the reset; and
if an error occurred, setting the error status indicator.

27. The automated storage library of claim 26, wherein:
the automated storage library further comprises an error flag; and
the embedded processor is further programmed to execute instructions for:
following the detection of a fatal error, determining if the error flag indicates a previous occurrence of an error;
if the error flag indicates the previous occurrence of an error, bypassing the storage of information about the fatal error and commencing the reset of the embedded processor; and
if the error flag does not indicate the previous occurrence of an error, setting the error flag to indicate the occurrence of the fatal error.

28. The automated storage library of claim 26, wherein the embedded processor is further programmed to execute instructions for:
if an error occurred, retrieving stored error information; and
clearing the error status indicator.

29. The automated storage library of claim 28, wherein:
the automated storage library further comprises an error flag; and
the embedded processor is further programmed to execute instructions for:
following the detection of a fatal error, determining if an error flag indicates a previous occurrence of an error;
if the error flag indicates the previous occurrence of an error, bypassing the step of storing information about the fatal error and commencing the reset of the embedded processor system;
if the error flag does not indicate the previous occurrence of an error, setting the error flag to indicate the occurrence of the fatal error; and
following the retrieval of the stored error information, clearing the error flag.

30. The automated storage library of claim 26, wherein:
the embedded processor comprises a distributed system having a plurality of nodes;
the instructions for detecting a fatal error comprise instructions for detecting a fatal error in a first node; and
the instructions for commencing a reset comprise instructions for commencing a reset of the first node.

31. A distributed embedded system, comprising:
a plurality of nodes;
means for detecting a fatal error in a first node;
means for storing information about the fatal error;
means for commencing a reset of the first node;
means for determining whether an error occurred prior to the commencement of the reset; and
an error status indicator for indicating if an error occurred.

32. The distributed embedded system of claim 31, further comprising:
an error flag for indicating an existence of a previous occurrence of an error following the detection of a fatal error;
means for commencing the reset of the embedded processor system without storing information about the fatal error if the error flag indicates the previous occurrence of an error; and
means for setting the error flag to indicate the occurrence of the fatal error if the error flag does not indicate the previous occurrence of an error.

33. The distributed embedded system of claim 31, further comprising:
means for retrieving stored error information if an error occurred; and
means for clearing the error status indicator.

34. The distributed embedded system of claim 33, further comprising:
following the detection of a fatal error, means for determining if an error flag indicates a previous occurrence of an error;
means commencing the reset of the embedded processor system without storing information if the error flag indicates the previous occurrence of an error;
means for setting the error flag to indicate the occurrence of the fatal error if the error flag does not indicate the previous occurrence of an error; and
means for clearing the error flag following the retrieval of the stored error information.
